(19) United States
(12) Patent Application Publication
(10) Pub. No.: US 2026/0244557 A1
(43) Pub. Date: Aug. 20, 2026

(54) GENERATING TEST FUNCTIONS FOR QUANTITATIVE PROMPT EVALUATION AND REFINEMENT

(71) Applicant: Bold Limited, Hamilton (BM)

(72) Inventors: Abhishek CHAUHAN, Uttar Pradesh (IN); Shailesh KRISHNA, Uttar Pradesh (IN); Mohit Kumar GOEL, Uttar Pradesh (IN)

(21) Appl. No.: 19/058,636

(22) Filed: Feb. 20, 2025

(51) Int. Cl. G06F 11/3668; G06F 40/186

(52) U.S. Cl. CPC G06F 11/3684; G06F 11/3692; G06F 40/186

(57) ABSTRACT

Certain aspects of the disclosure provide a method for generating test functions for prompt evaluation and refinement. In aspects, the method includes receiving a target prompt from a user; generating a first prompt for causing a language model to generate a task description associated with the target prompt; providing the first prompt to the language model; receiving the task description associated with the target prompt from the language model; generating a second prompt for causing the language model to generate, based on the task description, a set of test functions for quantitatively assessing outputs of the target prompt; providing the second prompt to the language model; receiving the set of test functions from the language model; and returning the set of test functions to the user.

### INTRODUCTION

### Technical Field

Aspects of the present disclosure relate to generating test functions for prompt evaluation and refinement.

### BACKGROUND

Organizations are increasingly incorporating language models into products and services involving generation of human-like text. For example, language models can support improvements in chatbots, content creation, question-response services, and more. Language models generate outputs based on an input prompt. The prompt provides context or instructions for guiding the language model to generate outputs for a given task. Thus, improved techniques related to prompt evaluation and refinement are desirable for promoting the implementation of prompts having increased quality and effectiveness for increasing the quality of generated language model outputs.

### SUMMARY

Certain aspects provide a method for generating test functions for prompt evaluation and refinement, the method including: receiving a target prompt from a user; generating a first prompt for causing a language model to generate a task description associated with the target prompt; providing the first prompt to the language model; receiving the task description associated with the target prompt from the language model; generating a second prompt for causing the language model to generate, based on the task description, a set of test functions for quantitatively assessing outputs of the target prompt; providing the second prompt to the language model; receiving the set of test functions from the language model; and returning the set of test functions to the user.

Other aspects provide processing systems configured to perform the aforementioned method as well as those described herein; non-transitory, computer-readable media comprising instructions that, when executed by a processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a test function generation system according to one or more aspects.

FIG. 2 depicts an illustrative process implemented by a test function generation system for generating test functions for prompt evaluation and refinement according to one or more aspects.

FIG. 3 depicts an illustrative table including scores obtained by evaluating a series of test outputs for a target prompt based on a set of test functions generated according to one or more aspects.

FIG. 4 depicts an example method for generating test functions for prompt evaluation and refinement according to one or more aspects.

FIG. 5 depicts an example processing system for enabling a test function generation system for generating test functions for prompt evaluation and refinement according to one or more aspects.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating test functions for prompt evaluation and refinement. For example, described aspects generate test functions for quantitatively evaluating a test output based on a target prompt based on one or more of objectives, expected outputs, and/or evaluation metrics associated with the target prompt.

Described aspects utilize specially programmed processing device(s) to generate specialized prompts for sequential processing by language models to assist in generating test functions that are context-specific with respect to a target prompt. As used herein a “target prompt” refers to a set of instructions for processing by a language model that may be input into a test function generation system in accordance with described aspects to cause the test function generation system to generate and return a test function for evaluating test outcomes of the target prompt.

Conventional techniques for evaluating and refining prompts often involve significant manual intervention, such as requiring prompt engineers to spend time manually reviewing language model outputs for a target prompt being evaluated, identifying areas of improvement, and adjusting the prompt or the language model's parameters accordingly. Thus, manual prompt evaluation and refinement is a time-consuming and costly approach that is prone to human-error and inconsistencies. Some conventional techniques instead utilize semi-automated quality control tools incorporating rule-based evaluation systems or certain machine learning algorithms for evaluating language model outputs for a given prompt against a predefined a set of criteria or rules. However, rule-based evaluation systems often lack the flexibility to adapt to the nuances of different target prompts, each of which may include separate instructions, context, and use-cases, thereby reducing the effectiveness of the rule-based prompt evaluation. Rule-based prompt evaluation may further involve unnecessary and redundant evaluations for certain rules that are irrelevant with respect to a target prompt being evaluated. Additionally, semi-automated quality control tools incorporating rule-based evaluation systems or certain machine learning algorithms for flagging potential issues often rely on significant human oversight to ensure the flagged issues are relevant for a given domain, do not miss critical errors, and are contextually appropriate.

Aspects described herein provide a technical solution for the aforementioned technical problems by providing systems and methods for leveraging language models to generate test functions for prompt evaluation and refinement. More specifically, described aspects generate sequential prompts that are provided to a language model to return test functions for evaluating a target prompt, thereby providing a framework that is automated and free from the human error associated with the aforementioned conventional techniques discussed above. Described aspects generate and provide a language model with a first prompt for causing the language model to generate a task description including one or more of objectives, expected outputs, and evaluation metrics associated with a target prompt. Described aspects then receive and utilize the task description for a target prompt to generate a second prompt configured to cause the language model to generate and return a set of test functions for evaluating the target prompt. The task description leveraged by the second prompt ensures that the generated and returned test functions for evaluating the target prompt are based on comprehensive context information specific to the target prompt, thereby overcoming the lack of nuance of conventional techniques that rely upon rule-based systems or simplistic machine learning algorithms that are not context-specific with respect to a target prompt. For example, the task description may include objectives, expected outcomes, and/or evaluation metrics specific to the target prompt for providing additional context. Described aspects further provide techniques for generating specially designed prompts that are both automated and adaptable for generating and returning test functions for evaluating any target prompt regardless of the specific context or evaluation metrics. Accordingly, described aspects overcome the reliance of conventional techniques on prompt engineers to manually review outputs, adjust evaluation model parameters, and identify areas for improvements for target prompts of different types.

Described aspects for generating test functions for prompt evaluation and refinement provide various technical benefits. As an example, described aspects provide automated techniques for generating tests for prompt evaluation, thereby providing the technical benefit of improved scalability for handling large volumes of prompts efficiently across multiple domains and services without investing increased human capital. Additionally, by leveraging generated task descriptions associated with a target prompt, described aspects generate targeted context-specific test functions that reduce unnecessary and redundant computations often introduced by conventional techniques employing rigid rule-based or manually-implemented evaluation metrics which may not be equally applicable to all target prompts. By reducing unnecessary and redundant computations, described aspects provide the technical benefit of increasing efficiency in resource utilization (e.g. such as by reducing memory usage, processing unit usage, storage usage, etc.) during prompt evaluation using test functions generated according to described aspects.

### Example Systems and Methods for Generating Test Functions for Prompt Evaluation

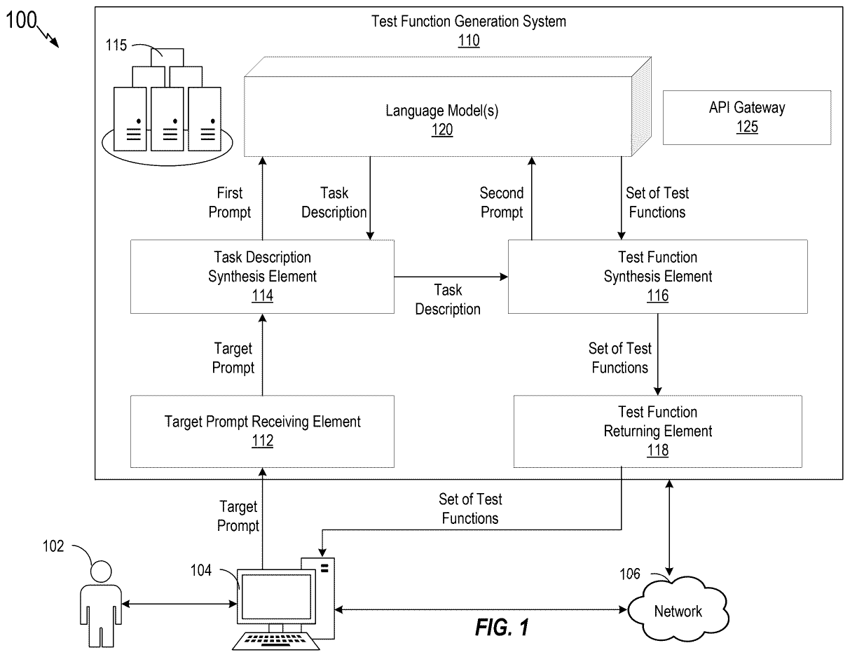

FIG. 1 depicts an illustrative environment 100 for implementing a test function generation system 110 according to one or more aspects.

The test function generation system 110 may be configured to interface with a user 102 seeking to generate a test function for evaluating a target prompt. Test function generation system 110 may be employed as a standalone application (e.g. installed on a device) or may be employed by a local or web-based application or platform including multiple systems or tools therein. User 102 may interface with aspects of test function generation system 110, for example implemented by one or more computing devices 115, through a device 104. In certain aspects, device 104 may be a personal computer, a tablet computer, a smart device (e.g., a smartphone), or the like.

In certain aspects, device 104 includes a display device for implementing a user interface with the respective user 102, one or more processors for executing logic and one or more non-transitory computer-readable mediums for storing information and/or computer readable instructions. In certain aspects, device 104 operates as an interface for interacting with test function generation system 110 via a suitable user interface provided by test function generation system 110 via computing devices 115. In aspects, device 104 may access test function generation system 110 via any suitable data network 106, such as the Internet. In certain aspects, test function generation system 110 performs processes for generating test functions for prompt evaluation and refinement using one or more computing devices 115. The one or more computing devices 115 (sometimes referred to as “processing systems”) of test function generation system 110 may include one or more processors and one or more non-transitory computer-readable mediums (e.g., memories) storing computer readable instructions that, when executed by the one or more processors, cause the one or more computing devices to perform processes defined by computer-readable instructions corresponding to one or more components depicted and described herein.

Test function generation system 110 is further configured to communicate with (using one or more components described below) and leverage language model(s) 120. In some examples, described aspects utilize language models 120 that are hosted locally (e.g., within an organizations network domain) within test function generation system 110. However, described aspects further include an API gateway 125 configured to enable test function generation system 110 to interact with third-party hosted language models (e.g., by making API calls).

A language model is generally a type of machine learning model that is designed to understand, generate, and manipulate human language. More specifically, a language model is a probabilistic framework that determines the likelihood of a sequence of words or tokens. At its core, a language model attempts to predict the probability of the next word in a sentence given the preceding words. The model estimates these probabilities based on the patterns it learned during training. Language models are useful in natural language processing (NLP) and computational linguistics for performing a range of tasks involving human language.

Language models may be characterized by various components and capabilities. For example, a language model may include a vocabulary that defines the set of all possible words or tokens that the model can recognize and use. This includes common words, punctuation, and possibly domain-specific jargon. Language models may also consider a context, which refers to the preceding words in a sentence or sequence that the model uses to predict the next word. Modern language models often incorporate extensive context windows, leveraging entire sentences or even paragraphs.

Language model may be implemented in various ways. For example, N-gram models predict the next word based on the previous N−1 words. Neural network-based language models include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

Language models are often trained using large corpora of text. The training process involves adjusting the model's parameters to minimize the difference between its predicted word probabilities and the actual word sequences in the training data. This is typically done via techniques like maximum likelihood estimation and gradient descent.

Language models have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Described aspects utilize language model 120 for providing certain features and benefits when generating test functions for prompt evaluation and refinement, thereby providing various solutions to shortcomings of conventional techniques, as well as certain technical benefits.

Test function generation system 110 further includes a target prompt receiving element 112. Target prompt receiving element 112 is configured to receive target prompts input by user 102. Target prompts are received as an input to test function generation system 110 and may be created manually or using automated techniques such as by prompting language model 120, or a different language model (e.g., another locally hosted or third party language model) to generate a target prompt based on a preliminary task description or a use-case template. As used herein a “preliminary task description” refers to a simple high-level statement outlining a primary goal or intended outcome for a given task without further providing specific instructions or formatting for performing the task and returning expected outputs. As used herein, a “use-case template” refers to a structured framework describing an objective, that may include actors, scenarios, and expected outcomes but that has not been designed for direct input into a prompt or a language model.

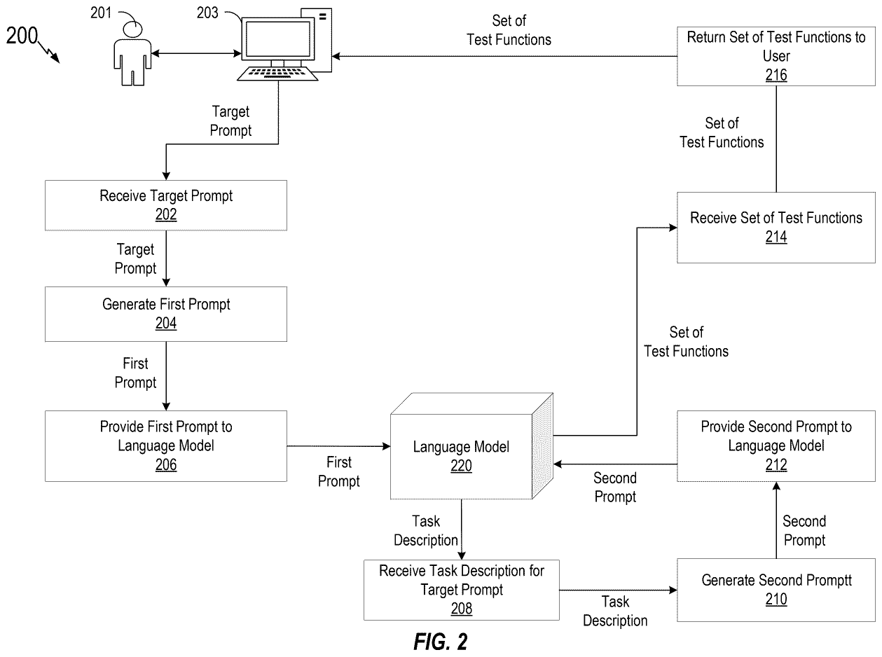

Test function generation system 110 also includes a task description synthesis element 114 configured to generate a first prompt for causing a language model to generate a task description for the target prompt. As used herein, a “task description” refers to a set of information for a target prompt that defines the purpose and functionality of the target prompt for a specific use case based on objectives of the prompt, expected outputs from the language model for the target prompt, and evaluation metrics for the target prompt. The task description functions as a bridge between abstract concepts of a target prompt and executable tasks. “Objectives” for the target prompt refer to goals the prompt is intended to achieve, such as generating a summary or extracting a user's preferences. “Expected outcomes” of the target prompt refer to desired or anticipated results from the prompts execution including, but not limited to, expected outputs (e.g. summaries, answers, values, etc.), expected accuracy of outputs, expected format or structures of outputs, and expected tones and styles for outputs. “Evaluation metrics” refer to criteria or standards for measuring quality, relevance, and effectiveness of output generated for a target prompt. The evaluation metrics may include, but are not limited to measures of relevance (e.g. degree to which an output aligns with the input context or prompt objective), completeness (e.g. whether all required components or information is included in the output), clarity (e.g. readability or comprehensiveness of the output), conciseness (e.g. whether the output adheres to a length constraint), and fidelity (e.g. how well the outputs align with the instructions and any included tone or domain-specific terminology). The above examples of objectives, expected outcomes, and evaluation metrics are illustrative and non-limiting, and additional elements may be added or omitted as may be useful for evaluating and refining a given target prompt having a unique domain and context. Illustrative task descriptions that may be generated and returned for a target prompt by language model 120 in accordance with described aspects are described in greater detail below with reference to illustrative process 200 of FIG. 2.

Test function generation system 110 further includes a test function synthesis element 116 configured to generate a second prompt configured to cause language model 120 to generate and return a set of test functions for evaluating the target prompt. Test function synthesis element 116 generates the second prompt based on a task description associated with the target prompt. Thus, the second prompt is specially configured to cause a language model to return a set of test functions for evaluating the target prompt based on a set of information (within the task description) that provides context in the form of objectives, expected outcomes, and/or evaluation metrics for the target prompt. By generating test functions that are focused on task descriptions for the target prompt, described aspects provide the technical benefit of streamlining downstream processing time and reducing latency during the evaluation process (e.g. using the returned set of test functions), as the returned test functions avoid consideration of irrelevant or generic metrics that may be considered if evaluating a target prompt using conventional rule-based systems or simplistic machine learning algorithms. This further increases downstream efficiency in resource utilization (e.g. such as by reducing memory usage, central processing unit usage, storage usage, etc.) during prompt evaluation.

Test function generation system 110 also includes a test function returning element 118 configured to return a received set of test functions to the user 102 via device 104. For example, test function returning element 118 may be configured to return a received set of test functions to user 102 using device 104. The return test functions may then be displayed via a suitable user interface (for example, provided by the one or more computing devices 115 of test function generation system 110) viewable by user 102 using device 104.

FIG. 2 depicts an illustrative process 200 implemented by a test function generation system, such as test function generation system 110 of FIG. 1, for generating test functions for prompt evaluation and refinement according to one or more aspects.

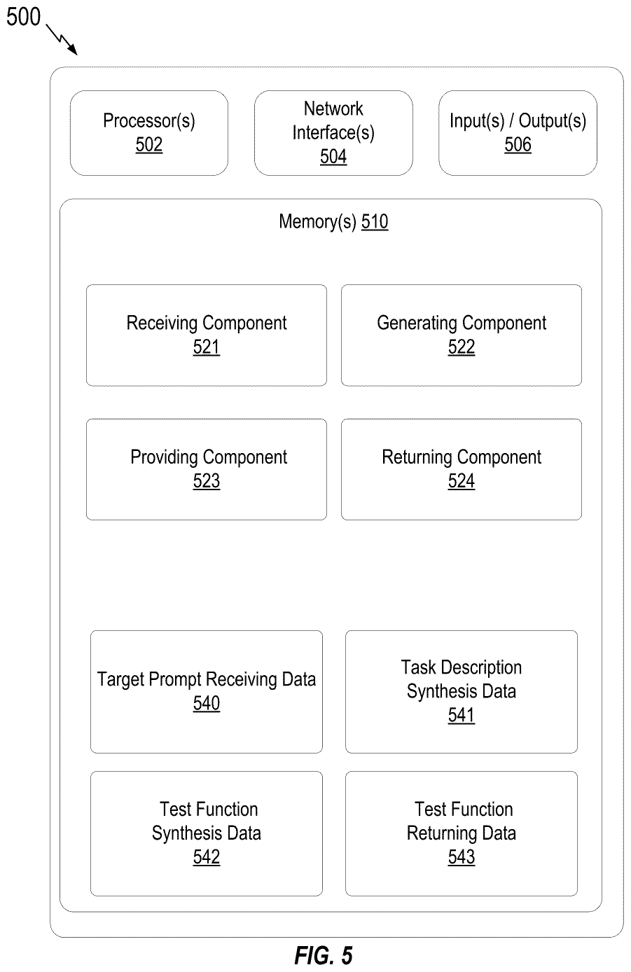

At 202, the test function generation system receives a target prompt, for example, using a target prompt receiving element, such as target prompt receiving element 112 with reference to FIG. 1 and receiving component 521 with reference to FIG. 5. The target prompt receiving element may receive a target prompt from a user 201 interfacing with a suitable user interface via a device 203.

The target prompt may include instructions for causing the language model to generate a corresponding output when processing the target prompt. In some examples, the target prompt may be a compound prompt. As used herein, a “compound prompt” refers to any singular prompt including multiple elements or sets of instructions therein for causing a language model to simultaneously address one or more multi-layered tasks having one or more objectives. In some examples, the target prompt may include a prompt chain including multiple distinct prompts to be processed sequentially across iterative steps, such as for enabling the generation of intermediate outputs and subsequent refinement.

For example, a portion of a target prompt may include instructions stating “generate 15 skills based on a set of work history statements and educational information. Divide the skills into three categories including job-specific skills, broad occupation skills, and soft skills, with 5 skills in each category.” The target prompt may further include additional instructions, such as a desired output structure, a length restriction, a formatting restriction, a specific linguistic rules for a desired output, or any other suitable additional instructions for performing a task or objective of the target prompt. For example, the example target prompt may further include additional instructions indicating that the output structure should be in JavaScript Object Notation (JSON) structure with a length restriction of no more than three words per generated skill. The same example prompt may further include additional instructions for restricting the use of gerunds (e.g. skills ending in “ing” such as “managing”) and for ensuring the output skills follow sentence case formatting.

At 204, described aspects generate a first prompt configured to cause a language model to generate and return a task description for the target prompt. For example, a task description synthesis element, such as task description synthesis element 114 with reference to FIG. 1, may generate a prompt for causing a language model to generate a task description including objectives, expected outcomes, and/or evaluation metrics for the target prompt. In such an example, the task description synthesis element utilizes the target prompt as input into a prompt template, for example, stored within task description synthesis data 541 of memory 510 with reference to FIG. 5, to generate the first prompt for causing language model 220 to return the task description associated with the target prompt. Returning to the example target prompt discussed above having the objective of “Generating 15 skills based on a set of work history statements and educational information. Divide the skills into three categories including job-specific skills, broad occupation skills, and soft skills, with 5 skills in each category”, the first prompt generated by described aspects at 204 causes language model 220 to generate a task description that outlines expected outcomes and evaluation metrics, such as an expected output structure formulated as:

### Output Must Follow a JSON Structure:

{“Output”:[“skill0”,“skill1”,“skill2”,“skill3”,“skill4”,“skill5”,“skill 6”,“skill7”,“skill8”,“skill9”,“skill10”,“skill11”,“skill12”,“skill13”,“skill14”]}”)

The task description for the same example may further include, for example, an expected quantity of output elements (e.g. “Exactly 15 skills should be generated), an expected length requirement (e.g. “Each skill must be 2 to 3 words long”), a list of restricted wording (e.g. “Skills should not contain the words “expertise” or “knowledge”), an expected format (e.g. “Skills should follow sentence case formatting”), and any other instructions or context related to expected outcomes and evaluation metrics.

The first prompt may further be configured to cause the language model to return a task description that includes a first section for outlining the objectives and instructions for achieving the objective, and a separate second section for outlining requirements useful as criteria or evaluation metrics for evaluating generated outputs. For example, a generated first prompt may be configured to cause a language model to generate an example task description for the example prompt above which has a first section outlining a task and instructions stating the following:
Your task is to assess the quality of a generated list of resume skills created by an expert resume writer using provided user inputs. The user inputs include an individual's education section and work experience statements. The list should consist of 15 important skills divided equally among job-specific skills, broad occupation-related skills, and soft skills. Evaluate how well these skills align with potential career goals derived from the education section and ensure they are desirable to employers in this field.

The first prompt may further be configured to cause the language model to generate a second section outlining requirements useful as criteria or evaluation metrics for evaluating generated outputs stating the following:
(a) Skills must be 2-3 words in length.
(b) Avoid basic, one-word skills like “reliability” or “friendliness” and suggest field-specific alternatives.
(c) Remove unnecessary modifier words such as “expertise”, “proficiency”, “knowledge”, “excellence”, “understanding” or “abilities” from skills, maintaining simple naming conventions.
(d) Ensure skills are formatted in sentence case.
(e) Rewrite skills that start with verbs or use-ing forms as nouns.

Accordingly, the first prompt is configured to cause the language model to generate a task description having distinct sections for magnifying different features and requirements of the target prompt. Thus, the generated task description serves as an effective input into a second prompt template for generating a second prompt configured to cause the language model to generate test functions for quantitatively evaluating the target prompt based on the evaluation metrics and requirements outlined in the task description, as described below in greater detail at 210.

At 206, described aspects provide the first prompt to a language model 220, such as using providing component 523 with reference to FIG. 5 to pass the first prompt from the task description synthesis element, such as task description synthesis element 114 with reference to FIG. 1, to the language model 220. In aspects, a task description synthesis element is configured to provide the first prompt to a locally hosted language model. In some examples, described aspects may be configured to send prompts and receive generated output from language model 220 using one or more API calls, for example, using API gateway 125 described above with reference to FIG. 1. Language model 220 may then process the provided prompt to generate a task description for the target prompt.

At 208, described aspects receive the task description associated with the target prompt from the language model 220. For example, a task description synthesis element, such as task description synthesis element 114 with reference to FIG. 1 may receive the task description associated with the target prompt and pass it to a test function synthesis element, such as test function synthesis element 116 with reference to FIG. 1.

At 210, described aspects then use the received task description to generate a second prompt configured to cause the language model 220 to generate a set of test functions for quantitatively evaluating one or more outputs of the target prompt, such as, using generating component 522 described below with reference to FIG. 5 and test function synthesis element 116 described above with reference to FIG. 1. For example, the test function synthesis element may generate the second prompt using a prompt template, such as stored within test function synthesis data 542 of memory 510 with reference to FIG. 5, designed to incorporate the target prompt and the associated task description received at 208 for generating a set of test functions for quantitatively evaluating one or more test outputs of the target prompt. By incorporating the received task description, the second prompt ensures that the generated test functions are useful for evaluating test outputs based on objectives, expected outcomes, and evaluation metrics for the target prompt. For example, the second prompt may cause language model to generate a set of test functions for evaluating, for test outputs of a target prompt, such as whether output structure, output tense, and output format are consistent with what was outlined in the generated task description (e.g. such as based on the objectives, expected outcomes, and evaluation metrics of the target prompt).

The second prompt may further be configured to ensure the generated set of test functions are useful for quantitatively evaluating the test output of the target prompt based on one or more rules or instructions within the target prompt. The rules or instructions of the target prompt may include additional requirements or details in the target prompt that affect the desired output, but may not have been included within the categories of information captured within the generated task description. For example, the target prompt may include a rule or instruction requiring that the target prompt ensure there is no direct repetition or duplicate phrases within an output. As such, the second prompt may cause the language model to generate one or more test functions for evaluating test outputs of the target prompt based on the additional rules or instructions. The second prompt may further be designed to indicate any suitable programming language for the language model to use for generating the set of test functions. In some examples, the second prompt may be configured to cause the language model to generate a set of one or more python test functions.

The previously discussed format of the generated task description, such as including distinct sections for magnifying different features and requirements of the target prompt, improves the effectiveness of the generated second prompt in causing the language model to generate a set of test functions that are based on one or more of the objectives, the expected outputs, and the evaluation metrics associated with the target prompt. That is, compartmentalizing the features of the target prompt in different sections of the task description reduces the risk of the language model unintentionally omitting certain features due to the complexity of the target prompt causing the language model to unintentionally omit or mischaracterize one or more features. In turn, the set of test functions returned by the language model processing the second prompt will have improved quality, ensuring the test functions are suitable for evaluating test outputs based on output structure, output tense, and output format that are aligned with comprehensive features and requirements of the target prompt.

At 212, described aspects provide language model 220 with the second prompt for causing language model 220 to generate the set of test functions for evaluating outputs of the target prompt. Described aspects may provide the second prompt in a similar manner as described above with reference to 206. Language model 220 will then process the second prompt to generate the set of test functions. In certain aspects, one or more different language models may be employed for carrying out techniques of illustrative process 200, as may be advantageous for performing different functions or for generating and returning test functions that may have increased compatibility with a given language model type or corresponding target prompt.

At 214, described aspects receive the set of test functions from the language model, for example, at test function synthesis element 116 with reference to FIG. 1. In certain aspects, the test functions may be formatted as a binary test function for returning one of a “true indication” if a condition or evaluation metric is met, or a “false indication” if a condition or evaluation metric is not met. The test functions may further be configured to generate a numeric score based on a returned true indication or a returned false indication. For example, returning to the target prompt having an expected output structure as described above at 204, the returned set of test functions from the language model may include a test function for evaluating if output structure for a test output of the target prompt is consistent with the expected JSON output structure. The test function may be configured to return one of a “true” indication if the expected output structure is followed, or a “false” indication if the expected output structure is not followed. The test function may be configured to then generate a numeric score based on a returned true indication or a returned false indication. For example, a returned true indication may be quantified as a numerical score of 1, while a “false” indication may be quantified as a numerical score of 0. By aggregating or averaging resulting scores for a quantity of test outputs, each test function of a returned set of test functions may be used to quantitatively assesses and evaluate the effectiveness of the target prompt in generating outputs consistent with a given objective, expected outcome, or evaluation metrics being measured by each respective test function. An illustrative first test function for evaluating the output structure (such as in the example described above at 204) may be formulated as:

```
  “response_data = json.loads(response)
if “Output” in response_data and isinstance(response_data[“Output”], list):
  results[“json_structure_check”] = True
    skills = response_data[“Output”]”
```

A second illustrative test function for evaluating whether a test output for the target prompt is consistent with an output length requirement (such as in the example described above at 204 for a target prompt configured to generate an output that is 15 skills long) may be formulated as:

if len(skills) == 15:
results[“skills_length_check”] = True

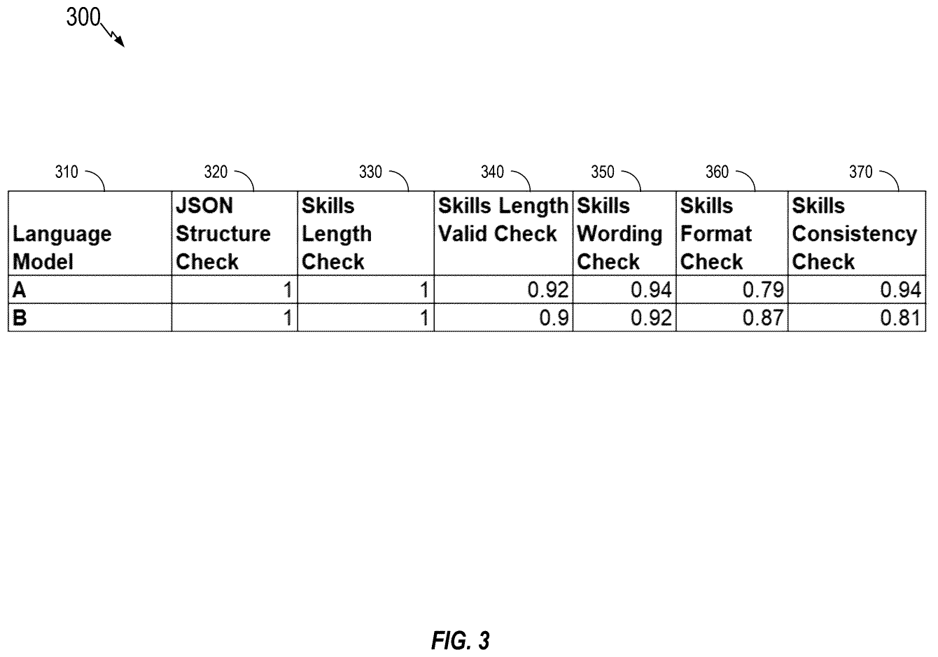

At 216, described aspects return the received set of test functions to user 201 via device 203, for example, using test function returning element 118 described above with reference to FIG. 1. The test function generation system may send the received set of test functions to device 203 for displaying within a user interface of an application or web-based platform employing a test function generation system according to described aspects. Use of returned sets of test functions generated in accordance with described aspects for quantitatively evaluating target prompts are better understood in view of example data shown in FIG. 3 and described below.

FIG. 3 depicts an illustrative table 300 including scores obtained by evaluating a series of test outputs for a target prompt based on a set of test functions generated according to one or more aspects. Table 300 contains a first column 310 including a first “Language Model A” and a second “Language Model “B” for which separate scores were obtained to evaluate the performance of an example target prompt on each respective model. Each of columns 320, 330, 340, 350, 360, and 370 of table 300 include scores representing aggregated percentage values for a given test function of a set of test functions generated for evaluating a series of outputs of a given target prompt. As an example, if 100 test outputs for a target prompt are evaluated using a test function “A”, a score of 0.92 may indicate that the test function “A” returned a “True” indication for 92 of the 100 test outputs. As shown, each of columns 320 (associated with a test function for scoring test outputs based on expected JSON structure) and 330 (associated with a test function for scoring test outputs based on whether the “skills length” included a list of exactly 15 skills) are shown as having a score of 1. This indicates that all test outputs input into the test functions associated with columns 320 and 330 returned a “True” indication, resulting in a score of 1 for both “Language Model A” and “Language Model B”.

In contrast, column 360 is associated with a test function for evaluating whether test outputs for the target function include skills returned in an expected format, such as sentence case format. As shown, column 360 includes a first score of 0.79 for “Language A”, and a second score of 0.87 for “Language Model B”. Thus, the test function associated with column 360 returned scores indicating that test outputs for the target prompt return skills in an expected format more often when using “Language Model B”. Accordingly, test functions generated using test function generation system enable users to quantitatively evaluate the precision and effectiveness of a target across multiple language models, thereby facilitating selection of a most efficient model for a target prompt.

While table 300 compares a target prompt across different language models, in other examples, the test functions may be used to compare scores for a series of test outputs generated by a first version of a target prompt and a second version of the target prompt executed on a single language model, thereby evaluating whether a modification or refinement of a given prompt improves or worsens the generated outputs. In another example, test functions in accordance with described aspects may be configured to return scores in various formats other than percentages of “True” indications returned, such as returning averaged scores obtained by adding and averaging scores of 1 and 0 (or other selected values) associated with respective “True” and “False” indications received for respective test outputs input into each test function. The example shown in table 300 is merely illustrative, and other suitable techniques for scoring and evaluating test outputs using test functions generated by described aspects are envisioned.

Because test functions generated in accordance with described aspects are further specific to evaluating a given feature, such as the features described above (e.g. an objective, expected output, expected structure, expected format, etc.), users are provided with increased flexibility to evaluate different versions of target prompts. For example, a user may utilize a first returned test function for a “Target Prompt A” and a second returned test function for a refined “Target Prompt B”. The user may then utilize the returned test functions for quantitatively evaluating whether test outputs for each version of the target prompt more or less effective for returning outputs satisfying a specific output feature or evaluation metric. Utilizing returned test functions generated in accordance with described aspects that are specific to features of the target prompt can thus be useful for reducing unnecessary and redundant computations, increasing efficiency in resource utilization (e.g. such as by reducing memory usage, processing unit usage, storage usage, etc.) during prompt evaluation as compared to more generic automated evaluation techniques.

### Example Method for Generating Test Functions for Prompt Evaluation and Refinement

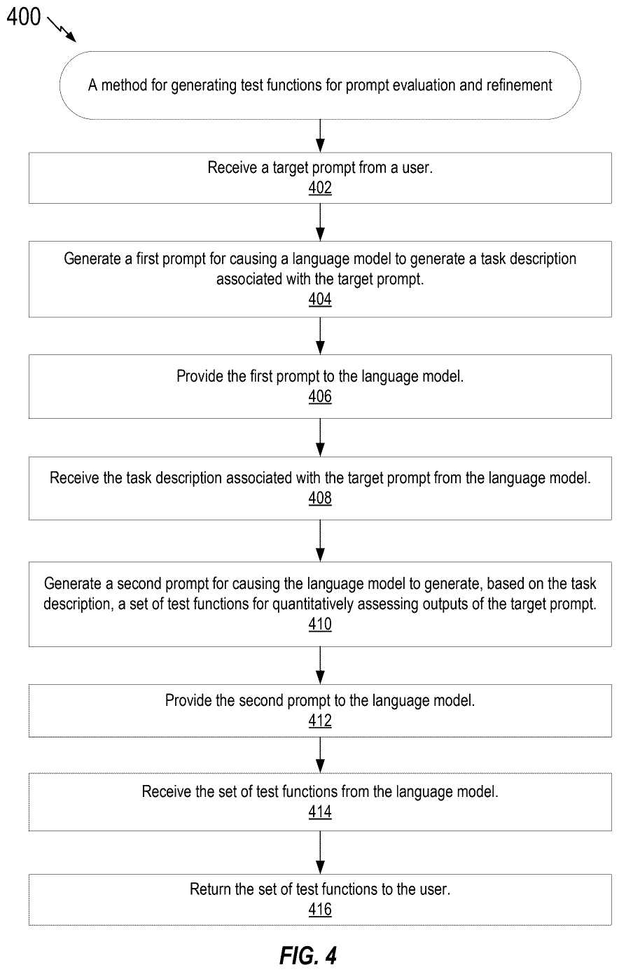

FIG. 4 depicts an example method 400 for generating test functions for prompt evaluation and refinement according to one or more aspects.

Method 400 begins at block 402 with receiving a target prompt from a user. For example, block 402 may be performed by the one or more processing systems 500 described below with reference to FIG. 5, configured to implement components including, but not limited to, a receiving component 521. As another example, block 402 may be performed by a target prompt receiving element 112 described above with reference to FIG. 1 for performing corresponding processes, for example, corresponding to 202 of process 200 described above with reference to FIG. 2.

Method 400 proceeds to block 404 with generating a first prompt for causing a language model to generate a task description associated with the target prompt. For example, block 404 may be performed by the one or more processing systems 500 described below with reference to FIG. 5, configured to implement components including, but not limited to, a generating component 522. As another example, block 404 may be performed by task description synthesis element 114 described above with reference to FIG. 1 for performing corresponding processes, for example, corresponding to 204 of process 200 described above with reference to FIG. 2.

Method 400 proceeds to block 406 with providing the first prompt to the language model. For example, block 406 may be performed by the one or more processing systems 500 described below with reference to FIG. 5, configured to implement components including, but not limited to, a providing component 523. As another example, block 406 may be performed by task description synthesis element 114 described above with reference to FIG. 1 for performing corresponding processes, for example, corresponding to 206 of process 200 described above with reference to FIG. 2

Method 400 proceeds to block 408 with receiving the task description associated with the target prompt from the language model. For example, block 408 may be performed by the one or more processing systems 500 described below with reference to FIG. 5, configured to implement components including, but not limited to, receiving component 521. As another example, block 408 may be performed by task description synthesis element 114 described above with reference to FIG. 1 for performing corresponding processes, for example, corresponding to 208 of process 200 described above with reference to FIG. 2

Method 400 proceeds to block 410 with generating a second prompt for causing the language model to generate, based on the task description, a set of test functions for quantitatively evaluating outputs of the target prompt. For example, block 410 may be performed by the one or more processing systems 500 described below with reference to FIG. 5, configured to implement components including, but not limited to, generating component 522. As another example, block 410 may be performed by test function synthesis element 116 described above with reference to FIG. 1 for performing corresponding processes, for example, corresponding to 210 of process 200 described above with reference to FIG. 2.

Method 400 proceeds to block 412 with providing the second prompt to the language model. For example, block 412 may be performed by the one or more processing systems 500 described below with reference to FIG. 5, configured to implement components including, but not limited to, providing component 523. As another example, block 412 may be performed by test function synthesis element 116 described above with reference to FIG. 1 for performing corresponding processes, for example, corresponding to 212 of process 200 described above with reference to FIG. 2.

Method 400 proceeds to block 414 with receiving the set of test functions from the language model. For example, block 414 may be performed by the one or more processing systems 500 described below with reference to FIG. 5, configured to implement components including, but not limited to, receiving component 521. As another example, block 414 may be performed by test function synthesis element 116 described above with reference to FIG. 1 for performing corresponding processes, for example, corresponding to 214 of process 200 described above with reference to FIG. 2

Method 400 proceeds to block 416 with returning the set of test functions to the user. For example, block 416 may be performed by the one or more processing systems 500 described below with reference to FIG. 5, configured to implement components including, but not limited to, a returning component 524. As another example, block 410 may be performed by test function returning element 118 described above with reference to FIG. 1 for performing corresponding processes, for example, corresponding to 216 of process 200 described above with reference to FIG. 2.

In some aspects, the task description includes one or more of objectives, expected outputs, and evaluation metrics associated with the target prompt.

In some aspects, the target prompt includes a compound prompt including multiple elements and context for causing the language model to perform a multi-layered task.

In some aspects, the target prompt is manually written.

In some aspects, the target prompt is generated by a different language model based on a prompt template.

In some aspects, the set of test functions are configured for quantitatively evaluating a test output of the target prompt based on the one or more of the objectives, the expected outputs, and the evaluation metrics associated with the target prompt.

In some aspects, the second prompt is configured to cause the language model to generate test functions for quantitatively evaluating the test output of the target prompt based on one or more of output structure, output tense, and output format.

In some aspects, the second prompt is configured to cause the language model to generate test functions for quantitatively evaluating the test output of the target prompt based on one or more rules or instructions within the target prompt.

Method 400 thus provides technical solutions to overcome shortcomings of conventional techniques for evaluating and refining prompts. More specifically, method 400 utilizes specially designed prompts to provide flexibility and ensure comprehensive context information specific to a given target prompt is leveraged when generating a test function for prompt evaluation, thereby overcoming the lack of nuance of conventional techniques that rely upon rule-based systems or simplistic machine learning algorithms. Described aspects for performing method 400 provide automated and adaptable techniques for generating and returning test functions to evaluate any target prompt having a unique set of quality metrics, thereby overcoming the reliance of conventional techniques on prompt engineers to manually review outputs, adjust evaluation model parameters, and identify areas for improvements. Method 400 generates targeted and context-specific test functions for a given target prompt based on a generated task descriptions associated with the target prompt. Accordingly, test functions generated and returned using method 400 reduce unnecessary or redundant computations that may be introduced by conventional prompt evaluation techniques employing rigid rule-based or manually-implemented evaluation metrics, thereby providing the technical benefit of reducing memory usage and computation costs during prompt evaluation using the generated test functions.

FIG. 4 is just one example of a method, and other methods including fewer, additional, or alternative steps are possible consistent with this disclosure.

### Example Processing System for Generating Test Functions for Prompt Evaluation and Refinement

FIG. 5 depicts an example processing system 500 upon which one or more aspects shown and described herein may be implemented.

The processing system 500 includes one or more processors 502. Generally, processor(s) 502 may be configured to execute computer-executable instructions (e.g., software code) to perform various functions, as described herein.

The processing system 500 further includes a network interface(s) 504, which generally provides data access to any sort of data network, including personal area networks (PANs), local area networks (LANs), wide area networks (WANs), the Internet, and the like.

The processing system 500 further includes input(s) and output(s) 506, which generally provide means for providing data to and from the processing system 500, such as via connection to computing device peripherals, including user interface peripherals.

The processing system 500 further includes one or more memories 510. Memory(s) 510 are configured to store various types of components and data.

In this example, memory 510 includes a receiving component 521, a generating component 522, a providing component 523, and a returning component 524.

Receiving component 521 may be configured to perform processes, for example, corresponding to blocks 402, 408, and 414 of method 400 described above with reference to FIG. 4. Receiving component 521 may further be configured to perform processes, for example, corresponding to 202, 208, and 214 of process 200 described above with reference to FIG. 2.

Generating component 522 may be configured to perform processes, for example, corresponding to blocks 404 and 410 of method 400 described above with reference to FIG. 4. Generating component 522 may further be configured to perform processes, for example, corresponding to 202, 204, and 210 of process 200 described above with reference to FIG. 2.

Providing component 523 may be configured to perform processes, for example, corresponding to blocks 406 and 412 of method 400 described above with reference to FIG. 4. Providing component 523 may further be configured to perform processes, for example, corresponding to 206 and 212 of process 200 described above with reference to FIG. 2.

Returning component 524 may be configured to perform processes, for example, corresponding to block 416 of method 400 described above with reference to FIG. 4. Returning component 524 may further be configured to perform processes, for example, corresponding to block 216 of process 200 described above with reference to FIG. 2.

In this example, memory 510 also includes target prompt receiving data 540, task description synthesis data 541, test function synthesis data 542, and test function returning data 543.

The processing system 500 may be implemented in various ways. For example, the processing system 500 may be implemented within on-site, remote, or cloud-based computing devices.

The processing system 500 is just one example, and other configurations are possible. For example, in alternative aspects, aspects described with respect to the processing system 500 may be omitted, added, or substituted for alternative aspects.

### EXAMPLE CLAUSES

Implementation examples are described in the following numbered clauses:

Clause 1: A method for generating test functions for prompt evaluation and refinement, comprising: receiving a target prompt from a user; generating a first prompt for causing a language model to generate a task description associated with the target prompt; providing the first prompt to the language model; receiving the task description associated with the target prompt from the language model; generating a second prompt for causing the language model to generate, based on the task description, a set of test functions for quantitatively assessing outputs of the target prompt; providing the second prompt to the language model; receiving the set of test functions from the language model; and returning the set of test functions to the user.

Clause 2: The method of Clause 1, wherein the task description comprises one or more of objectives, expected outputs, and evaluation metrics associated with the target prompt.

Clause 3: The method of Clause 2, wherein the target prompt comprises a compound prompt including multiple elements and context for causing the language model to perform a multi-layered task.

Clause 4: The method of any one of Clauses 1-3, wherein the target prompt is manually written.

Clause 5: The method of any one of Clauses 1-4, wherein the target prompt is generated by a different language model based on a prompt template.

Clause 6: The method of any one of Clauses 1-5, wherein the set of test functions are configured for quantitatively assessing a test output of the target prompt based on the one or more of the objectives, the expected outputs, and the evaluation metrics associated with the target prompt.

Clause 7: The method of any one of Clauses 1-6, wherein the second prompt is configured to cause the language model to generate test functions for quantitatively evaluating the test output of the target prompt based on one or more of output structure, output tense, and output format.

Clause 8: The method of any one of Clauses 1-7, wherein the second prompt is configured to cause the language model to generate test functions for quantitatively evaluating the test output of the target prompt based on one or more rules or instructions within the target prompt.

Clause 9: The method of any one of Clauses 1-8, wherein the test functions comprise binary test functions for returning one of a true indication or a false indication.

Clause 10: The method of any one of Clauses 1-9, wherein the test functions are further configured to generate a numeric score corresponding to a returned true indication or a returned false indication.

Clause 11: A processing system, comprising means for performing a method in accordance with any one of Clauses 1-10.

Clause 12: A non-transitory computer-readable medium comprising computer-executable instructions that, when executed by one or more processors of a processing system, cause the processing system to perform a method in accordance with any one of Clauses 1-10.

Clause 13: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating test functions for prompt evaluation and refinement, comprising:
receiving a target prompt from a user;
generating a first prompt for causing a language model to generate a task description associated with the target prompt;
providing the first prompt to the language model;
receiving the task description associated with the target prompt from the language model;
generating a second prompt for causing the language model to generate, based on the task description, a set of test functions for quantitatively evaluating outputs of the target prompt;
providing the second prompt to the language model;
receiving the set of test functions from the language model; and
returning the set of test functions to the user.

2. The method of claim 1, wherein the task description comprises one or more of objectives, expected outputs, and evaluation metrics associated with the target prompt.

3. The method of claim 1, wherein the target prompt comprises a compound prompt including multiple elements and context for causing the language model to perform a multi-layered task.

4. The method of claim 1, wherein the target prompt is manually written.

5. The method of claim 1, wherein the target prompt is generated by a different language model based on a use-case template.

6. The method of claim 2, wherein the set of test functions are configured for quantitatively evaluating a test output of the target prompt based on the one or more of the objectives, the expected outputs, and the evaluation metrics associated with the target prompt.

7. The method of claim 6, wherein the second prompt is configured to cause the language model to generate test functions for quantitatively evaluating the test output of the target prompt based on one or more of output structure, output tense, and output format.

8. The method of claim 6, wherein the second prompt is configured to cause the language model to generate test functions for quantitatively evaluating the test output of the target prompt based on one or more rules or instructions within the target prompt.

9. The method of claim 1, wherein the test functions comprise binary test functions for returning one of a true indication or a false indication for a given output of the target prompt.

10. The method of claim 9, wherein the test functions are further configured to generate a numeric score corresponding to a returned true indication or a returned false indication for the given output of the target prompt.

11. A processing system, comprising:
one or more memories comprising computer-executable instructions; and
one or more processors configured to execute the computer-executable instructions causing the processing system to:
receive a target prompt from a user;
generate a first prompt for causing a language model to generate a task description associated with the target prompt;
provide the first prompt to the language model;
receive the task description associated with the target prompt from the language model;
generate a second prompt for causing the language model to generate, based on the task description, a set of test functions for quantitatively evaluating outputs of the target prompt;
provide the second prompt to the language model;
receive the set of test functions from the language model; and
return the set of test functions to the user.

12. The processing system of claim 11, wherein the task description comprises one or more of objectives, expected outputs, and evaluation metrics associated with the target prompt.

13. The processing system of claim 11, wherein the target prompt comprises a compound prompt including multiple elements and context for causing the language model to perform a multi-layered task.

14. The processing system of claim 11, wherein the target prompt is manually written.

15. The processing system of claim 11, wherein the wherein the target prompt is generated by a different language model based on a use-case template.

16. The processing system of claim 12, wherein the set of test functions are configured for quantitatively evaluating a test output of the target prompt based on the one or more of the objectives, the expected outputs, and the evaluation metrics associated with the target prompt.

17. The processing system of claim 16, wherein the second prompt is configured to cause the language model to generate test functions for quantitatively evaluating the test output of the target prompt based on one or more of output structure, output tense, and output format.

18. The processing system of claim 16, wherein the second prompt is configured to cause the language model to generate test functions for quantitatively evaluating the test output of the target prompt based on one or more rules or instructions within the target prompt.

19. The processing system of claim 11, wherein the test functions comprise binary test functions for returning one of a true indication or a false indication for a given output of the target prompt.

20. The processing system of claim 19, wherein the test functions are further configured to generate a numeric score corresponding to a returned true indication or a returned false indication for the given output of the target prompt.
